(19) United States
(12) Patent Application Publication
(10) Pub. No.: US 2013/0206692 A1
(43) Pub. Date: Aug. 15, 2013

(54) Tanning wastewater treatment and recycling method based on nano-catalytic electrolysis technology and membrane technology

(71) Applicant: Shiwen Zhang, Xiamen (CN)

(72) Inventor: Shiwen Zhang, Xiamen (CN)

(21) Appl. No.: 13/882,196

(22) PCT Filed: Jul. 1, 2011
(86) PCT No.: PCT/CN11/76746

§ 371 Date: Apr. 28, 2013

(30) Foreign Application Priority Data
Oct. 28, 2010 (CN) 201010522958.9

(51) Int. Cl. C02F 9/00

(52) U.S. Cl. CPC C02F 9/00
USPC 210/638; 210/151

(57) ABSTRACT

A tanning wastewater treatment and recycling method based on nano-catalytic electrolysis technology and membrane technology relates to a tanning wastewater treatment. The tanning wastewater treatment and recycling method based on the nano-catalytic electrolysis technology and the membrane technology and a device thereof has a high COD removal rate, a low chemicals consumption, few sludges, thorough treatment, and a high reuse rate of water. The tanning wastewater treatment and recycling device based on the nano-catalytic electrolysis technology and the membrane technology includes: a coarse grid filtering machine, a regulating pool, a hydraulic sieve, a nano-catalytic electrolytic machine, a reaction pool, a sedimentation pool, an air flotation device, a biochemical pool, a secondary sedimentation pool, a secondary nano-catalytic electrolytic machine, a filter and a membrane system. The method includes: nano-catalytic electrolysis, flocculation, biochemical treatment, secondary catalytic electrolysis, filtration, and membrane filtration.

### CROSS REFERENCE OF RELATED APPLICATION

This is a U.S. National Stage under 35 U.S.C 371 of the International Application PCT/CN 2011/076746, filed Jul. 1, 2011, which claims priority under 35 U.S.C. 119(a-d) to CN 201010522958.9, filed Oct. 28, 2010.

### BACKGROUND OF THE PRESENT INVENTION

1. Field of Invention

The present invention relates to a tanning wastewater treatment, and more particularly to a tanning wastewater treatment and recycling method based on nano-catalytic electrolysis technology and membrane technology.

2. Description of Related Arts

According to statistics, China's tanning industry discharges more than 100 million tons wastewater into the environment every year, which accounts for about 0.3% of total emission of the industrial wastewater of China. The tanning industry ranks third in the wastewater emission per unit output value, only next to the papermaking and brewing industry. Obviously, the tanning industry not only consumes large amounts of fresh water resources, but also discharges a large amount of wastewater, which poses a serious threat to human's health and the sustainable development of the whole society. Therefore the wastewater treatment should be strengthened. It is necessary to treat the wastewater and reuse the reclaimed water, to not only save the fresh water resources but also protect the environment, which has important practical significance and strategic significance.

The wastewater discharged in the tanning industry has problems of high concentration of organic pollution, large amount of suspended matter, large amount of the wastewater, complex components of the wastewater, etc., and the wastewater contains toxic matter, such as sulfur and chrome. According to the production process, the wastewater of the tanning industry comprises seven parts, which are wash water of the raw skin and acid soaking containing high concentration of chloride, strong alkaline hair-removal liming wastewater containing lime and sodium sulphide, blue chrome tanning wastewater containing trivalent chromium, tan tanning wastewater containing tannin and gallic acid, defatted wastewater containing fat and its saponification material, fatliquoring and dyeing wastewater, and washing wastewater of various stages, wherein the defatted wastewater, hair-removal liming wastewater, and chrome tanning wastewater pollute the environment most seriously.

(1) The Defatted Wastewater

Pigskin production accounts for 80% of the tanning production in China. In the defatted wastewater of the pigskin production, the oil content reaches to 10000 (mg/L), and the CODCr reaches to 20000 (mg/L). The oil wastewater accounts for 4% of the total wastewater, but the oxygen consumption load of oil wastewater accounts for 30%˜40% of the total load.

(2) The Hair-Removal Liming Wastewater

The hair-removal liming wastewater is the pollution source of the sulfide. The CODCr of the hair-removal liming wastewater is 20000-40000 (mg/L), the BOD is 54000 (mg/L), sodium sulfide is 1200˜1500 (mg/L), and pH value is 12. The hair-removal liming wastewater accounts for 10% of the total wastewater, but the oxygen consumption load accounts for 40% of the total load.

(3) The Chrome Tanning Wastewater

The chrome tanning wastewater is the pollution source of the trivalent chromium. In the chrome tanning process, the chromium salt adhesion rate is 60%˜70%, i.e. 30%-40% of chromium salt enters into the waste water. The Cr3+ of the chrome tanning wastewater is 3000-4000 (mg/L), the CODCr is 10000 (mg/L), and the BOD is 52000 mg/L.

In the conventional tanning wastewater treating technology, the wastewater of various stages of production are collected and mixed together, to be transmitted in the sewage treatment system. However, the wastewater tends to have inhibitory effects on the microorganisms, because of containing a lot of sulfide and chromium ions. Therefore the reasonable craft route at present is that the original liquid is treated separately and the synthetic wastewater is treated unifiedly, which comprises treating the defatted wastewater, the hair-removal liming wastewater, and the chrome tanning wastewater respectively, recycling valuable resources, and then mixing them with other wastewater for unified treatment.

The wastewater collected in various production stages of the tanning factory is called the tanning synthetic wastewater. The tanning wastewater has high contents of organic matter, sulfide, and chromium compound, and a large oxygen consumption. The tanning synthetic wastewater pollutes the environments seriously, which is mainly embodied in following aspects.

(1) Chroma

The tanning wastewater has a large chroma, which is caused by discharge liquids of vegetable tanning, dyeing, chrome tanning and barilla.

(2) Alkaline

The tanning wastewater is generally alkaline, and the synthetic wastewater has a pH value of 8-12, which is caused by lime, caustic soda, and sodium sulfide used in the stage of hair removal.

(3) Sulfide

The sulfide in the tanning wastewater is mainly from the discharge liquid of barilla hair removal, and minor part of the sulfide is from the sulfide discharge liquid for soaking to soften the leather and the decomposed products of the protein. The sulfur-containing discharge liquid tends to produce the H2S gas under condition of acids, and the sulfur-containing sludges release H2S gas under condition of anaerobism.

(4) Chromium Ion

The chromium ions in the tanning wastewater mainly exist in the state of Cr³⁺, and the content is commonly 100 mg/L˜3000 mg/L. In general, after the wastewater is treated by neutralization precipitation, the wastewater is filtered and transmitted into the synthetic wastewater pool.

(5) Organic Pollutants

The tanning wastewater has a high content of the organic pollutant comprising the protein, and also contains a certain amount of reducing substances, so the content of the BOD5 and the CODCr is very high.

The wastewater discharged from various stages of the tanning process differs greatly in the quality. The synthetic wastewater collected from various stages has a pH value of 8-12, high concentrations of chroma, CODCr, SS and BOD5, and high concentrations of the poisonous and harmful substances and the salts. The quality (average value of the test) of the synthetic wastewater of the tanning industry is illustrated in following Table 1.

| pH | Chroma (times) | CODCr | SS | NH₃—N | S²⁻ | Cr | BOD5 |
|---|---|---|---|---|---|---|---|
| 8~12 | 500~3500 | 3000~4000 | 2000~4000 | 250~300 | 50~100 | 100~3000 | 1500~2000 |

Note:
The units are mg/L, except pH and chroma.

Currently, the treating method of the tanning wastewater mainly comprises: a coagulation and sedimentation method, an adsorption method, an advanced oxidation technology, a direct recycling and reusing method, an air flotation method, an adding acid absorption method, a catalytic oxidation method, a biochemical method, etc., and each method has its various advantages and disadvantages. Because the effect is difficult to be achieved via a single method, in practice, several methods are usually combined to be used, according to the actual situation of treating the wastewater. Huang Zhenxiong introduced that a tannery in Guangdong combined the flocculation and sedimentation method, activated sludge method and contact oxidation method to treat the tanning wastewater. The treating effect is stable since the treating method started to be used in December 2003. The COD of the inflow is 3000˜3500 mg/L, and the COD of the outflow is 40 mg/L. All of the outflow indexes are up to the first grade of the local standard of Guangdong province (DB44/26-2001). Zhang jie used sequencing batch reactor activated sludge process (SBR) to treat the wastewater of a tannery in Henan. Firstly, a large amount of toxic substances and organic matter in the wastewater are removed via materialization method. Secondly, soluble organic matter is biochemically decomposed via SBR method. The design daily treating capacity is 800 m³. When the COD of inflow is 2500 mg/L, the COD of outflow is about 100 mg/L, which is much lower than the second grade of the national standard (COD<300 mg/L). The operating cost of the project is 0.8 yuan/ton. The running result shows that when applying the SBR method to treat the wastewater, the adaptability for the change of the water quality is good, and the capacity of resisting impact load is strong. The SBR method is especially suitable for the situation that the wastewater is discharged relatively concentratedly and the water quality is changeable. In addition, the SBR process requires a low investment, and the operating cost is lower than general activated sludge methods. Jia Qiuping applied a method combining vortex concave air flotation and two stage biological contact oxidation process to reform the wastewater treating facilities of a tannery in Shenyang. The treated wastewater is up to the discharge standard, and the treating capacity and the effect are improved. More than 80% of the Cr³⁺ is recycled, in such a manner that a part of the treated wastewater is reused. After being treated by this method, when the COD of the inflow is 3647 mg/L, the COD of the outflow is 77 mg/L, which is lower than the second grade (COD<100 mg/L) of the newly changed and expanded standard of Liaoning province (DB21-60-89). Yang Jianjun and Gao Zhongbai introduced the method combining materialization process and oxidation ditch process to Shipaoying tanning estate in Xinji. The original jet aerator wastewater treating system is reformed, and its capacity is increased. After the reformation, the treating capacity is increased to 4800 m³/d, and the system is able to effectively treat the wastewater having an inflow of 6100 mg/L in COD. Practical operation shows that the reformed process is high in treating efficiency, and the quality of the outflow is up to the second grade of the national synthetic discharge standard of the wastewater. Tao Rujun introduced a method combining process of coagulating sedimentation, hydrolysis acidification and CAST to a tanning industrial zone of Zhejiang, to treat the synthetic wastewater from stages of preparing, tanning and other wet processing. The maximum design inflow rate is 6000 m³/d. FeSO₄ and the coagulant aid PAC is added into the reaction pool after preparation, then the sulfur ions in wastewater is remove by settling down. Cr³⁺ is removed by reacting with NaOH in the reaction pool and settle down. The biochemical treatment adopts the method combining anaerobic-aerobic process and aerobic process. The anaerobic-aerobic process adopts contact-type hydrolysis acidification process to increase the biodegradability of the wastewater and remove parts of the COD and the SS. The aerobic process adopts the CAST process as the improved SBR process, and has a high removal rate of organic matter and a strong capacity of resisting impact load. Sun Yabing et exposed a tanning wastewater treating method base on electrolytic treatment in a Chinese patent CN100371268C. The removal rate of the COD of the treated wastewater is 60%˜80%. The removal rate of the ammonia nitrogen is 50%˜70%. The removal rate of the sulfide is more than 95%. The removal rate of the suspended solids is 70%˜80%. The removal rate of the chroma is more than 85%. The killing rate of the colibacillus is more than 99%. However, this method has disadvantages of high consumption of positive pole and energy.

In summary, the conventional method not only has advantages of high consumption of materials, high discharge of sludges, high discharge of wastewater, large waste of water resources, high cost and not being up to the recycling standard of the reclaimed water in the industrial waste, but also has a series of problems of complicated operation, tending to bring secondary pollutions, and being difficult to popularize and apply. Therefore, a new wastewater treating method is urgently required, which has a low consumption of raw materials, a low discharge of sludges, a simple operation, and a low cost. After being treated by this new method, the wastewater is able to be reused as reclaimed water, in such a manner that the material consumption per unit product in the tanning process is reduced, the fresh water resources is saved, and the environment is protected.

### SUMMARY OF THE PRESENT INVENTION

An object of the present invention is to provide a tanning wastewater treatment and recycling method based on nano-catalytic electrolysis technology and membrane technology and a device thereof having advantages of high COD removal rate, low chemicals consumption, few sludges, thorough treatment, and high reuse rate of water, to solve disadvantages of conventional tanning wastewater treatment methods, such as high chemicals consumption, large sludge discharge, large waste of water resources, high cost, complicated operation, and tending to bring secondary pollutions.

The tanning wastewater recited in the present invention refers to mixed wastewater collected in various workshop sections, which is called synthetic wastewater.

Accordingly, in order to accomplish the above objects, the present invention provides a tanning wastewater treatment and recycling device based on nano-catalytic electrolysis technology and membrane technology, comprising: a coarse grid filtering machine, a regulating pool, a hydraulic sieve, a nano-catalytic electrolytic machine, a reaction pool, a sedimentation pool, an air flotation device, a biochemical pool, a secondary sedimentation pool, a secondary nano-catalytic electrolytic machine, a filter and a membrane system, wherein a wastewater inlet of the coarse grid filtering machine is connected with a synthetic wastewater source, a filtered wastewater outlet of the coarse grid filtering machine is connected with an inlet of the regulating pool, an inlet of the hydraulic sieve is connected with a wastewater outlet of the regulating pool, an inlet of the nano-catalytic electrolytic machine is connected with an outlet of the hydraulic sieve, an outlet of the nano-catalytic electrolytic machine is connected with an inlet of the reaction pool, an outlet of the reaction pool is connected with an inlet of the sedimentation pool, precipitates outflowing from a sedimentation outlet of the sedimentation pool are pumped into a pressure filter via a pipeline to be filtered and separated into filtrate and sludges, a wastewater outlet of the sedimentation pool is connected with an inlet of the air flotation device, residues outflowing from a residue outlet in an upper portion of the air flotation device are pumped into the pressure filter via a pipeline to be filtered and separated into filtrate and sludges, the filtrate outflowing from a filtrate outlet of the pressure filter flows into the biochemical pool via a pipeline, a wastewater outlet in a lower portion of the air flotation device is connected with the biochemical pool via a pump, an outlet of the biochemical pool is connected with an inlet of the secondary sedimentation pool, an outlet for the biochemically treated wastewater in an upper portion of the secondary sedimentation pool is connected with an inlet of the secondary nano-catalytic electrolytic machine, precipitates outflowing from a sedimentation outlet in a bottom of the secondary sedimentation pool are pumped into the pressure filter via a pipeline to be filtered and separated into filtrate and sludges, the filtrate flows into the secondary sedimentation pool via a pipeline, a wastewater outlet of the secondary nano-catalytic electrolytic machine is connected with an inlet of the filter, an outlet for the wastewater filtered by the filter is connected with an inlet of the membrane system, and the membrane system has a dialysate (reusable water) outlet and a concentrate outlet.

The tanning wastewater treatment and recycling method based on nano-catalytic electrolysis technology and membrane technology recited in the present invention comprises following steps of:

1) Nano-Catalytic Electrolysis,

wherein tanning synthetic wastewater flows into a coarse grid filtering machine, after removing large particulate solids, the tanning synthetic wastewater flows into a regulating pool to mix, then the wastewater in the regulating pool is pumped into a hydraulic sieve, and after impurities comprising hairs are filtered and removed, the wastewater flows into a nano-catalytic electrolytic machine to be electrolyzed;

wherein, in the step 1), the nano-catalytic electrolytic machine has an electrolysis working voltage of 2-500V, a voltage between two poles of 2-8V, and an electrolytic density of 10-300 mA/cm², a retention time of the wastewater in the nano-catalytic electrolytic machine is 5-15 min, and electricity consumption of electrolyzing the wastewater is 8-1.2 kilowatt hour/m³;

2) Flocculation,

wherein the wastewater electrolyzed by the nano-catalytic electrolytic machine in the step 1) flows into a reaction pool, then flocculant, coagulant aid and air flotation agent prepared in advance are added into the reaction pool, after a flocculation reaction, the wastewater flows into a sedimentation pool to be separated, precipitates in an lower portion of the sedimentation pool are pumped into a pressure filter via a pipeline to be filtered and separated into filtrate and sludges, the wastewater in an upper portion of the sedimentation pool flows into an air flotation device to be separated via air flotation, residues separated in an upper portion of the air flotation device are pumped into the pressure filter via a pipeline to be filtered and separated into filtrate and sludges, the filtrate flows into a biochemical pool via a pipeline, and the wastewater in an lower portion of the air flotation device is pumped into the biochemical pool;

3) Biochemical Treatment,

wherein the wastewater in the lower portion of the air flotation device, which is treated by the flocculation in the step 2), is pumped into the biochemical pool, the wastewater is treated by an aerobic method or a method combining anaerobic treatment and aerobic treatment, and then is separated by settling in a secondary sedimentation pool, the wastewater treated by a biochemical treatment outflows from an upper portion of the secondary sedimentation pool, sediment in a bottom of the secondary sedimentation pool is pumped into the pressure filter via a pipeline to be filtered and separated into filtrate and sludges, the filtrate flows into the secondary sedimentation pool via a pipeline, and after the biochemical treatment, the biochemically-treated wastewater separated by settling in the secondary sedimentation pool is obtained;

4) Secondary Catalytic Electrolysis,

comprising transmitting the biochemically-treated wastewater outflowing from the upper portion of the secondary sedimentation pool into a secondary nano-catalytic electrolytic machine to electrolyze the wastewater;

wherein, in the step 4), an electrolysis working voltage of the secondary nano-catalytic electrolytic machine is 2-400V, an optimum working voltage is 13-200V, a voltage between two poles is 2-8V, an optimum voltage between the two poles is 3-5V, a current density is 10-300 mA/cm², an optimum current density is 150-230 mA/cm², a retention time of the wastewater in the secondary nano-catalytic electrolytic machine is 2-6 min, an optimum retention time is 3-4 min, and a degree of electrolysis is 0.8˜1.0 kilowatt hour/m³;

5) Filtration,

comprising filtering the wastewater electrolyzed by the secondary nano-catalytic electrolytic machine with a filter, and removing solid impurities;

wherein, in the step 5), the filter is a sand filter, a multi-media filter, or a microfiltration membrane system, the wastewater is filtered by the filter, and the wastewater outflowing from the filter 11 has a chroma of 1-10, a COD of 30˜200 mg/L, an ammonia nitrogen concentration of 0-5 mg/L, and an SS of 0-10 mg/L.

6) Membrane Filtration,

comprising filtering the wastewater filtered by the filter with a membrane system to obtain dialysate (reusable water) and concentrate, wherein the dialysate is reused, and the concentrate is discharged;

wherein, in the step 6), the membrane system is a nanofiltration membrane system or a reverse osmosis membrane system, a membrane module of the nanofiltration membrane system is a roll-type membrane module, a membrane material of the nanofiltration membrane system is a cellulose acetate membrane or a composite membrane of organic membranes, which has a molecular weight cutoff of 50˜200 MWCO, an inlet pressure of 6.0˜45.0 bar, and an outlet pressure of 4.5˜43.5 bar, and the dialysate (reusable water) filtered by the nanofiltration membrane system is a colorless liquid, which has a yield of 75%˜85%, a COD less than 30 mg/L, an ammonia nitrogen concentration less than 5 mg/L, no SS, and a removal rate of divalent ion more than 95%;

wherein a membrane module of the reverse osmosis membrane system is preferably a roll-type membrane module, a membrane material of the reverse osmosis membrane system is preferably a cellulose acetate membrane or a composite membrane of organic membranes, which has a molecular weight cutoff of 50˜200 MWCO, an inlet pressure of 6.0˜45.0 bar, and an outlet pressure of 4.5˜35 bar, and the dialysate (reusable water) filtered by the reverse osmosis membrane system is a colorless liquid, which has a yield of 60%˜75%, a COD less than 5 mg/L, an ammonia nitrogen concentration less than 1 mg/L, no SS, and a desalination rate more than 95%.

The present invention provides a design about treatment, purification and reuse process of wastewater, based on in-depth systematic contrastive studies on compositions and properties of the wastewater and conventional treatment schemes.

Compared with a method combined the flocculation and the biochemical treatment, the present invention has following advantages.

1) A dosage of flocculant is greatly reduced, a chemicals consumption required per unit of output is reduced, and a cost of medicament is saved.

2) A discharge of sludges is reduced, in such a manner that a cost of sludge treatment is reduced.

3) After being treated, 60%-85% of the wastewater is able to be recycled, in such a manner that a discharge of the wastewater is reduced to prevent the wastewater polluting the environment, and waste of water resources is also decreased to gain some economic benefits.

Compared with a method combined the flocculation, the biochemical treatment and the membrane filtration, the present invention has the following advantages.

1) A dosage of flocculant is greatly reduced, a chemicals consumption required per unit of output is reduced, and a cost of medicament is saved.

2) A discharge of sludges is reduced, in such a manner that a cost of sludge treatment is reduced.

3) The biochemically-treated wastewater in the secondary sedimentation pool is electrolyzed by the secondary nano-catalytic electrolytic machine, in order to further reduce the COD. Firstly, the reuse rate of the wastewater is increased, in such a manner that the discharge of the wastewater is reduced to prevent the wastewater polluting the environment, and waste of water resources is also decreased. Secondly, the microorganisms comprising bacteria in the wastewater are killed, in such a manner that biological pollution of the membrane are prevented, cleaning frequency of the membrane is decreased by a large margin, regeneration cost of cleaning the membrane is reduced, using efficiency of the membrane is increased, service life of the membrane is extended, and cost of replacing the membrane is reduced.

4) Total COD emissions of the wastewater is decreased by a large margin.

These and other objectives, features, and advantages of the present invention will become apparent from the following detailed description, the accompanying drawings, and the appended claims.

### BRIEF DESCRIPTION OF THE DRAWINGS

FIGURE is a sketch view of a composition of a tanning wastewater treatment and recycling device based on nano-catalytic electrolysis technology and membrane technology according to a preferred embodiment of the present invention.

### DETAILED DESCRIPTION OF THE PREFERRED EMBODIMENT

The present invention is further described in following embodiments according to the drawings.

Referring to the FIGURE, a tanning wastewater treatment and recycling device based on nano-catalytic electrolysis technology and membrane technology according to a preferred embodiment of the present invention is illustrated, comprises: a coarse grid filtering machine 1, a regulating pool 2, a hydraulic sieve 3, a nano-catalytic electrolytic machine 4, a reaction pool 5, a sedimentation pool 6, an air flotation device 7, a biochemical pool 8, a secondary sedimentation pool 9, a secondary nano-catalytic electrolytic machine 10, a filter 11 and a membrane system 12. A wastewater inlet of the coarse grid filtering machine 1 is connected with a synthetic wastewater source, a filtered wastewater outlet of the coarse grid filtering machine 1 is connected with an inlet of the regulating pool 2, an inlet of the hydraulic sieve 3 is connected with a wastewater outlet of the regulating pool 2, an inlet of the nano-catalytic electrolytic machine 4 is connected with an outlet of the hydraulic sieve 3, an outlet of the nano-catalytic electrolytic machine 4 is connected with an inlet of the reaction pool 5, an outlet of the reaction pool 5 is connected with an inlet of the sedimentation pool 6, precipitates outflowing from a sedimentation outlet of the sedimentation pool 6 are pumped into a pressure filter P via pipelines to be filtered and separated into filtrate and sludges, a wastewater outlet of the sedimentation pool 6 is connected with an inlet of the air flotation device 7, residues outflowing from a residue outlet in an upper portion of the air flotation device 7 are pumped into the pressure filter P via pipelines to be filtered and separated into filtrate and sludges, the filtrate outflowing from a filtrate outlet of the pressure filter flows into the biochemical pool 8 via pipelines, a wastewater outlet in a lower portion of the air flotation device 7 is connected with the biochemical pool 8 via a pump, an outlet of the biochemical pool 8 is connected with an inlet of the secondary sedimentation pool 9, an outlet for the biochemically-treated wastewater in an upper portion of the secondary sedimentation pool 9 is connected with an inlet of the secondary nano-catalytic electrolytic machine, precipitates outflowing from a sedimentation outlet in a bottom of the secondary sedimentation pool 9 are pumped into the pressure filter P via pipelines to be filtered and separated into filtrate and sludges, the filtrate flows into the secondary sedimentation pool 9 via pipelines, a wastewater outlet of the secondary nano-catalytic electrolytic machine 10 is connected with an inlet of the filter 11, a wastewater outlet of the filter 11 for wastewater filtered is connected with an inlet of the membrane system 12, and the membrane system 12 has a dialysate (reusable water) outlet and a concentrate outlet M.

Embodiments of a tanning wastewater treatment and recycling method based on nano-catalytic electrolysis technology and membrane technology are as followed.

### Embodiment 1

The tanning wastewater treatment and recycling method based on the nano-catalytic electrolysis technology and the membrane technology comprises:

step 1 of nano-catalytic electrolysis,

wherein tanning synthetic wastewater flows into a coarse grid filtering machine 1, after removing large particulate solids, the tanning synthetic wastewater flows into a regulating pool 2 to mix, then the wastewater in the regulating pool 2 is pumped into a hydraulic sieve 3, after filtering impurities comprising hairs, the wastewater flows into a nano-catalytic electrolytic machine 4 to be electrolyzed, the nano-catalytic electrolytic machine 4 has an electrolysis working voltage of 2-500V, a voltage between two poles of 2-8V, and an electrolytic density of 10-300 mA/cm², a retention time of the wastewater in the nano-catalytic electrolytic machine 4 is 5-15 min, and electricity consumption of electrolyzing the wastewater is 8-1.2 kilowatt hour/m³;

step 2 of flocculation,

wherein the wastewater electrolyzed by the nano-catalytic electrolytic machine 4 in the step 1 flows into a reaction pool 5, flocculant, coagulant aid and air flotation agent prepared in advance are added into the reaction pool 5, after a flocculation reaction, the wastewater flows into a sedimentation pool 6 to be separated, precipitates in an lower portion of the sedimentation pool 6 are pumped into a pressure filter via pipelines to be filtered and separated into filtrate and sludges, the wastewater in an upper portion of the sedimentation pool 6 flows into an air flotation device 7 to be separated via air flotation, residues separated in an upper portion of the air flotation device 7 are pumped into the pressure filter via pipelines to be filtered and separated into filtrate and sludges, the filtrate flows into a biochemical pool 8 via pipelines, and the wastewater in an lower portion of the air flotation device 7 is pumped into the biochemical pool 8;

step 3 of biochemical treatment,

wherein the wastewater in the lower portion of the air flotation device 7, which is treated by the flocculation in the step 2, is pumped into the biochemical pool 8, the wastewater is treated by an aerobic method or a method combining anaerobic treatment and aerobic treatment, and then is separated by settling in a secondary sedimentation pool 9, the wastewater treated by a biochemical treatment outflows from an upper portion of the secondary sedimentation pool 9, sediment in a bottom of the secondary sedimentation pool 9 is pumped into the pressure filter via pipelines to be filtered and separated into filtrate and sludges, the filtrate flows into the secondary sedimentation pool 9 via pipelines, after the biochemical treatment, the biochemically-treated wastewater separated by settling in the secondary sedimentation pool 9 has a chroma of 60-200, a COD of 80-300 mg/L, and an ammonia nitrogen concentration of 0˜30 mg/L;

step 4 of secondary catalytic electrolysis, comprising

transmitting the biochemically-treated wastewater outflowing from the upper portion of the secondary sedimentation pool 9 into a secondary nano-catalytic electrolytic machine 10 to electrolyze the wastewater, wherein an electrolysis working voltage is 2-400V, an optimum working voltage is 13-200V, a voltage between two poles is 2-8V, an optimum voltage between the two poles is 3-5V, a current density is 10-300 mA/cm², an optimum current density is 150˜230 mA/cm², a retention time of the wastewater in the secondary nano-catalytic electrolytic machine 10 is 2˜6 min, an optimum retention time is 3˜4 min, and a degree of electrolysis is 0.8˜1.0 kilowatt hour/m³;

step 5 of filtration, comprising

filtering the wastewater electrolyzed by the secondary nano-catalytic electrolytic machine 10 with a filter 11, and removing solid impurities;

wherein the filter 11 is a sand filter, a multi-media filter, or a microfiltration membrane system, the wastewater electrolyzed by secondary nano-catalytic electrolysis is filtered by the filter 11, the wastewater outflowing from the filter 11 has a chroma of 1-10, a COD of 30˜200 mg/L, an ammonia nitrogen concentration of 0-5 mg/L, and an SS of 0-10 mg/L.

step 6 of membrane filtration, comprising

filtering the wastewater filtered by the filter 11 with a membrane system 12 to obtain dialysate (reusable water) and concentrate, wherein the dialysate is reused, and the concentrate is discharged.

The membrane system 12 as recited above is preferably a nanofiltration membrane system, wherein a membrane module is preferably a roll-type membrane module, and a membrane material of a nanofiltration membrane is preferably a cellulose acetate membrane or a composite nanofiltration membrane of organic membranes, which has a molecular weight cutoff of 200-500 MWCO, an inlet pressure of 6.0˜45.0 bar, and an outlet pressure of 4.5˜43.5 bar. The dialysate (reusable water) filtered by the nanofiltration membrane system 12 is a colorless liquid, which has a yield of 75%˜85%, a COD less than 30 mg/L, an ammonia nitrogen concentration less than 5 mg/L, no SS, and a removal rate of divalent ion more than 95%.

The membrane system 12 as recited above is preferably a reverse osmosis membrane system, wherein a membrane module is preferably a roll-type membrane module, and a membrane material is preferably a cellulose acetate membrane or a composite membrane of organic membranes, which has a molecular weight cutoff of 50˜200 MWCO, an inlet pressure of 6.0˜45.0 bar, and an outlet pressure of 4.5˜35 bar. The dialysate (reusable water) filtered by the reverse osmosis membrane system 12 is a colorless liquid, which has a yield of 60%˜75%, a COD less than 5 mg/L, an ammonia nitrogen concentration less than 1 mg/L, no SS, and a desalination rate more than 95%.

### Embodiment 2

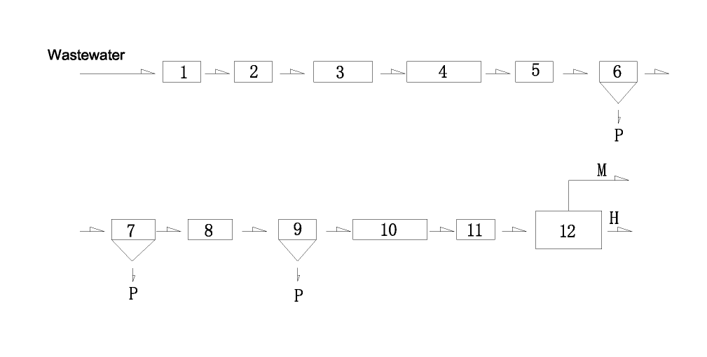

The embodiment of the tanning wastewater treatment and recycling method based on the nano-catalytic electrolysis technology and the membrane technology is described as followed, according to the embodiment of the tanning wastewater treatment and recycling device based on the nano-catalytic electrolysis technology and the membrane technology illustrated in FIG. 1.

A tanning wastewater treatment and recycling project having a daily treatment capacity of 300 ton

Indexes of the tanning wastewater (synthetic wastewater) determined is illustrated in Table 1.

TABLE 1

| NO. | Item | Unit | Value | NO. | Item | Item | Value |
|---|---|---|---|---|---|---|---|
| 1 | COD_{Cr} | mg/L | 3560 | 5 | BOD5 | mg/L | 1730 |
| 2 | SS | mg/L | 3110 | 6 | S² | mg/L | 82 |
| 3 | NH₃—N | mg/L | 265 | 7 | Chroma | | 3200 |
| 4 | Cr | mg/L | 120 | 8 | pH | | 9.3 |

The wastewater flows into the coarse grid filtering machine 1 at a current velocity of 15 m³/H, after removing large particulate solids, the wastewater flows into the regulating pool 2 to mix, then the wastewater in the regulating pool 2 is pumped into the hydraulic sieve 3 at a current velocity of 15 m³/H, after filtering foreign matter comprising hairs, the wastewater flows into the nano-catalytic electrolytic machine 4 to be electrolyzed, and the nano-catalytic electrolytic machine 4 has a working voltage of 48V, a current intensity of 375 A, and a voltage between two poles of 4.2V. The chloride (Cl) of a nascent state produced by nano-catalytic micro-electrolysis is able to kill microorganisms in the wastewater, oxidize and decompose the organic matter in the wastewater, and for suspended solids, colloid, and charged particles to form larger particles under an electric field. The wastewater electrolyzed flows into the reaction pool 5, lime, ferrous sulfate and polyacrylamide are added in, after a flocculation reaction, the wastewater flows into the sedimentation pool 6, precipitates in an lower portion of the sedimentation pool 6 are pumped into the pressure filter via pipelines to be filtered and separated into filtrate and sludges, the wastewater in an upper portion of the sedimentation pool 6 flows into the air flotation device 7 to be separated via air flotation, residues separated in an upper portion of the air flotation device 7 are pumped into the pressure filter via pipelines to be filtered and separated into filtrate and sludges, the filtrate flows into the biochemical pool 8 via pipelines, and the wastewater in an lower portion of the air flotation device 7 is pumped into the biochemical pool 8. The wastewater is treated by an aerobic method in the biochemical pool 8, and then the wastewater flows into a secondary sedimentation pool 9 to be separated by settling. The wastewater treated by a biochemical treatment outflows from an upper portion of the secondary sedimentation pool 9, sediment in a bottom of the secondary sedimentation pool 9 is pumped into the pressure filter via pipelines to be filtered and separated into filtrate and sludges, and the filtrate flows into the secondary sedimentation pool 9 via pipelines. After the biochemical treatment, the biochemically-treated wastewater separated by settling in the secondary sedimentation pool 9 has a chroma of 65, a COD of 265 mg/L, and an ammonia nitrogen concentration of 3.7 mg/L. The biochemically-treated wastewater outflowing from the upper portion of the secondary sedimentation pool 9 are transmitted into a secondary nano-catalytic electrolytic machine 10 to be electrolyzed, wherein an electrolysis working voltage is 40V, a current is 375 A, and a retention time of the wastewater in the secondary nano-catalytic electrolytic machine 10 is 4 min. The wastewater electrolyzed by the secondary nano-catalytic electrolytic machine 10 is filtered with the filter 11, and the electrolyzed wastewater filtered has a chroma of 6, a COD of 207 mg/L, an ammonia nitrogen concentration of 2.5 mg/L, and an SS of 3 mg/L. The electrolyzed wastewater filtered by a multi-media filter 11 flows into a nanofiltration membrane system 12, wherein a nanofiltration membrane module is preferably a roll-type membrane module, a membrane material of a nanofiltration membrane is preferably a cellulose acetate membrane having a molecular weight cutoff of 200 MWCO, an inlet pressure of 6.5 bar, and an outlet pressure of 4 bar. Dialysate (reusable water) filtered by the nanofiltration membrane system 12 has a yield of 80%. The quality of the dialysate (reusable water) is illustrated in Table 2.

TABLE 2

| NO. | Item | Unit | Value | NO. | Item | Item | Value |
|---|---|---|---|---|---|---|---|
| 1 | COD_{Cr} | mg/ | 9 | 4 | Chroma | | colorless |
| | | L | | | | | |
| 2 | SS | mg/ | 0 | 5 | pH | | 7.7 |
| | | L | | | | | |
| 3 | Tur- | NTU | 2 | 6 | Con- | μS/ | 1100 |
| | bid- | | | | duct- | cm | |
| | ity | | | | ivity | | |

### Embodiment 3

A tanning wastewater treatment and recycling project having a daily treatment capacity of 3000 ton

Indexes of the tanning wastewater (synthetic wastewater) determined is illustrated in Table 3.

TABLE 3

| NO. | Item | Unit | Value | NO. | Item | Item | Value |
|---|---|---|---|---|---|---|---|
| 1 | COD_{Cr} | mg/L | 3900 | 5 | BOD5 | mg/L | 1950 |
| 2 | SS | mg/L | 4070 | 6 | S² | mg/L | 92 |
| 3 | NH₃—N | mg/L | 283 | 7 | Chroma | | 2900 |
| 4 | Cr | mg/L | 93 | 8 | pH | | 9.3 |

The wastewater flows into the coarse grid filtering machine 1 at a current velocity of 150 m³/H, after removing large particulate solids, the wastewater flows into the regulating pool 2 to mix, then the wastewater in the regulating pool 2 is pumped into the hydraulic sieve 3 at a current velocity of 150 m³/H, after filtering foreign matter comprising hairs, the wastewater flows into the nano-catalytic electrolytic machine 4 to be electrolyzed, and the nano-catalytic electrolytic machine 4 has a working voltage of 380V, a current intensity of 3475 A, a voltage between two poles of 4.2V, and an electrolytic density of 230 mA/cm². The chloride (Cl) of a nascent state produced by nano-catalytic micro-electrolysis is able to kill microorganisms in the wastewater, oxidize and decompose organic matter in the wastewater, and for suspended solids, colloid, and charged particles to form larger particles under an electric field. The wastewater electrolyzed flows into the reaction pool 5, lime, ferrous sulfate and polyacrylamide are added in, after a flocculation reaction, the wastewater flows into the sedimentation pool 6, precipitates in an lower portion of the sedimentation pool 6 are pumped into the pressure filter via pipelines to be filtered and separated into filtrate and sludges, the wastewater in an upper portion of the sedimentation pool 6 flows into the air flotation device 7 to be separated via air flotation, residues separated in an upper portion of the air flotation device 7 are pumped into the pressure filter via pipelines to be filtered and separated into filtrate and sludges, the filtrate flows into the biochemical pool 8 via pipelines, and the wastewater in an lower portion of the air flotation device 7 is pumped into the biochemical pool 8. The wastewater is successively treated by an anaerobic method and an aerobic treatment in the biochemical pool 8, and then the wastewater flows into a secondary sedimentation pool 9 to be separated by settling. The wastewater treated by a biochemical treatment outflows from an upper portion of the secondary sedimentation pool 9, sediment in a bottom of the secondary sedimentation pool 9 is pumped into the pressure filter via pipelines to be filtered and separated into filtrate and sludges, and the filtrate flows into the secondary sedimentation pool 9 via pipelines. After the biochemical treatment, the biochemically-treated wastewater separated by settling in the secondary sedimentation pool 9 has a chroma of 85, a COD of 165 mg/L, and an ammonia nitrogen concentration of 1.5 mg/L. The biochemically-treated wastewater outflowing from the upper portion of the secondary sedimentation pool 9 are transmitted into a secondary nano-catalytic electrolytic machine 10 to be electrolyzed, wherein an electrolysis working voltage is 380V, a current is 3670 A, and a retention time of the wastewater in the secondary nano-catalytic electrolytic machine 10 is 3 min. The wastewater electrolyzed by the secondary nano-catalytic electrolytic machine 10 is filtered with the filter 11, and the electrolyzed wastewater filtered has a chroma of 8, a COD of 112 mg/L, an ammonia nitrogen concentration of 0.9 mg/L, and an SS of 1 mg/L. The electrolyzed wastewater filtered by a multi-media filter 11 flows into a reverse osmosis membrane system 12. As mentioned above, the membrane system 12 is preferably the reverse osmosis membrane system, wherein a membrane module is preferably a roll-type membrane module, a membrane material is preferably a composite membrane having a molecular weight cutoff of 50 MWCO, an inlet pressure of 15.0 bar, and an outlet pressure of 2.5 bar. Dialysate (reusable water) filtered by the reverse osmosis membrane system 12 has a yield of 75%. The quality of the dialysate (reusable water) is illustrated in Table 4.

TABLE 4

| NO. | Item | Unit | Value | NO. | Item | Item | Value |
|---|---|---|---|---|---|---|---|
| 1 | COD_{Cr} | mg/L | 0 | 4 | Chroma | | colorless |
| 2 | SS | mg/L | 0 | 5 | pH | | 6.5 |
| 3 | Tur- | NTU | 0.8 | 6 | Con- | μS/ | 50 |
| | bid- | | | | duct- | cm | |
| | ity | | | | ivity | | |

### Embodiment 4

The specific step is as followed.

Step 1 of Nano-Catalytic Electrolysis

After the tanning synthetic wastewater is nano-catalytic electrolyzed, strong oxidizing substances produced oxidize and decompose organic matter in the wastewater. OH⁻ produced by electrolysis react with some metal ions (e.g. Fe³⁺) to form precipitate. These precipitate particles play a role of coagulant aid to help suspended matter in the solution to gather and settle down. Meanwhile, the precipitate particles bring unstableness to the wastewater under effect of an electric field, in such a manner that colloid dissolved in the wastewater settles, and dosages of the flocculant, the coagulant aid and the air flotation agent in a process of flocculation in step 2 are decreased.

The nano-catalytic electrolytic machine comprises a positive electrode comprising a basal lamina made of titanium and an oxide coating applying on the basal lamina and a negative electrode made of titanium, stainless steel, aluminum, zinc, copper or graphite, wherein the oxide coating has a good catalytic effect and a crystalline grain of 15˜22. After the tanning wastewater is filtered by the grid filtering machine and the hydraulic sieve to remove the hairs, the tanning wastewater flows into the catalytic electrolytic machine having a working voltage of 2-500V, a voltage between two poles of 2-8V, and an electrolytic density of 10-260 mA/cm². The electrolysis time of the wastewater is 5-15 min, and the degree of electrolysis of the wastewater is 8-1.2 kilowatt hour/m³. A large number of strong oxidizing free radicals are produced in the electrolytic process, (The strong oxidizing free radicals produced are chlorine and hydroxyl in nascent states, when there is sodium chloride.) The strong oxidizing free radicals are able to oxidize and decompose organic matter in the wastewater quickly. The strong oxidizing free radicals break rings and scissor chains of big organic molecules, which are difficult to be biodegraded in the wastewater, in such a manner that the big molecules is decomposed into small molecules to provide a better condition for the biochemical treatment. Chromophores and auxochromes of dye molecules in the wastewater is oxidized or reduced to colorless groups, in such a manner that the wastewater is decolorized, the COD is decreased, the wastewater is easier to be biochemically treated and the BOD is increased by 15%-40%.

In addition, the nano-catalytic electrolysis also has some effects as followed.

1. Flocculation

OH— produced in the process of electrolysis react with some metal ions (e.g. Fe³⁺) to form precipitate which settles down. These precipitate particles play a role of coagulant aid to help suspended matter in the solution to gather and settle down. Additionally, in the process of electrolysis, the electric field is able to destroy in the colloidal structures in the wastewater, in such a manner that the colloidal structures become instable, flocculate and settle down, and the dosages of the flocculant, the coagulant aid and the air flotation agent in the process of flocculation are significantly decreased.

2. Decolorizing

The strong oxidizing free radicals produced in the electrolytic process are able to decompose structures of tanning dye molecules in the wastewater quickly, in order to reduce affects colored matter put on the chroma of water quality.

3. Sterilization and Disinfection

A large number of strong oxidizing free radicals are produced in the electrolytic process, such as chlorine in the nascent state, are able to kill microorganisms and viruses comprising bacteria in the wastewater quickly. The strong oxidizing free radicals have excellent sterilization and disinfection effects.

4. Air Flotation

Hydrogens produced by the negative electrode are able to form a large number of tiny air bubbles. With the air bubbles rising, large amounts of suspended solids and oil also rise. The air flotation realizes an effect of solid-liquid separation, in order to further decrease the COD, the chroma, and the turbidity of the wastewater.

Experience has proved that the electrolysis time of the wastewater is preferably 5-15 min. If the electrolysis time is too short, the flocculation effect and the decolorizing effect are poor. If the electrolysis time is too long, the flocculation effect and the decolorizing effect are better, but the power consumption is large, which is improper in aspect of economy.

Experience has also proved that the electrolysis time is related to a concentration of the wastewater. The higher the concentration is, the longer the electrolysis time is.

Experience has also proved that the voltage between the two poles in the process of electrolysis is related to a distance between the two poles. The shorter the distance is, the lower the voltage is. The voltage between the two poles is usually 2-8V, and the optimum voltage is 3-5V.

The catalytic electrolysis as recited in the step 1 has advantages as followed.

(1) The dosages of the flocculant and the coagulant aid in the step 2 are decreased by 40%70%, in such a manner that chemical consumption is greatly decreased, and the chemical secondary pollution is also decreased.

(2) A discharge of the sludge is decreased by 40%-70%.

Step 2 of Flocculation

The flocculant, the coagulant aid and the air flotation agent are added into the synthetic wastewater catalytically electrolyzed in the step 1. After flocculation reaction, the foreign substance is removed by air flotation.

As was mentioned above, the flocculation comprises adding the flocculant, the coagulant aid and the air flotation agent into the synthetic wastewater catalytically electrolyzed. The alkali is one of lime and sodium hydroxide. The flocculant is one of ferrous sulfate, ferric sulfate, ferric chloride and polymeric ferric sulfate. The coagulant aid is preferably polyacrylamide.

Step 3 of Biochemical Treatment

The wastewater treated by the flocculation in the step 2 is treated by an aerobic method or a method combining anaerobic treatment and aerobic treatment, and then is separated by settling in the secondary sedimentation pool, in such a manner that the biochemically-treated wastewater is obtained.

As was mentioned above, after the biochemical treatment, the biochemically-treated wastewater separated by settling in the secondary sedimentation pool has a chroma of 80-200, a COD of 80-300 mg/L, and an ammonia nitrogen concentration of 0˜30 mg/L.

Step 4 of Secondary Catalytic Electrolysis

The biochemically-treated wastewater is treated by the secondary catalytic electrolysis. The coloured matter in the wastewater is removed and the organic matter is oxidized and decomposed, in order to further decrease the COD of the wastewater.

As was mentioned above, the secondary catalytic electrolysis comprising transmitting the biochemically-treated wastewater outflowing from the secondary sedimentation pool into the secondary nano-catalytic electrolytic machine to catalytically electrolyze the wastewater, wherein the secondary nano-catalytic electrolytic machine has the electrolysis working voltage of 2-400V, the voltage between two poles of 2-8V, the current density of 10-300 mA/cm², the electrolytic time of 2-6 min, and the degree of electrolysis of 0.8˜1.0 kilowatt hour/m³. The optimum working voltage of the electrolysis is 13-200V, the optimum voltage between the two poles is 3-5V, and the optimum current density is 150-230 mA/cm². The strong oxidizing substances produced by the electrolysis oxidize and decompose organic matter in the wastewater, in such a manner that dyes in the wastewater is decomposed and decolorized, the COD is decreased, the microorganisms comprising bacteria are killed. Meanwhile, the wastewater becomes instable and flocculates.

Step 5 of Filtration Comprises Filtering the Wastewater Electrolyzed by the Secondary Nano-Catalytic Electrolytic Machine in the Step 4, to Remove the Solid Impurities.

As was mentioned above, the filtration recited in the step 5 is one of sand filtration, multi-media filtration, and microfiltration. The wastewater electrolyzed by the secondary nano-catalytic electrolytic machine is filtered by the sand filtration, the multi-media filtration, or the microfiltration, the wastewater filtered has the chroma of 1-10, the COD of 30˜200 mg/L, the ammonia nitrogen concentration of 0-5 mg/L, and the SS of 0-10 mg/L.

Step 6 of membrane filtration comprises filtering the wastewater filtered by the multi-media in the step 5 with a membrane filtration to obtain dialysate (reusable water) and concentrate, wherein the dialysate is reused, and the concentrate is discharged.

As was mentioned above, the membrane filtration in the step 6 is preferably a nanofiltration, the membrane module is preferably the roll-type membrane module, and a membrane material of a nanofiltration membrane is preferably a cellulose acetate membrane or a composite nanofiltration membrane of organic membranes, which has a molecular weight cutoff of 200-500 MWCO, an inlet pressure of 6.0˜45.0 bar, and an outlet pressure of 4.5˜43.5 bar.

As was mentioned above, the dialysate (reusable water) filtered by the nanofiltration membrane is a colorless liquid, which has a yield of 75%˜85%, a COD less than 30 mg/L, an ammonia nitrogen concentration less than 5 mg/L, no SS, and a removal rate of divalent ion more than 95%.

As was mentioned above, the membrane filtration in the step 6 is preferably a reverse osmosis filtration, the membrane module is preferably the roll-type membrane module, and the membrane material is preferably a cellulose acetate membrane or a composite membrane of organic membranes, which has a molecular weight cutoff of 50˜200 MWCO, an inlet pressure of 6.0˜45.0 bar, and an outlet pressure of 4.5˜35 bar.

As was mentioned above, the dialysate (reusable water) filtered by the reverse osmosis membrane is a colorless liquid, which has a yield of 60%˜80%, a COD less than 5 mg/L, an ammonia nitrogen concentration less than 1 mg/L, no SS, and a desalination rate more than 95%.

The present invention recited above comprises three parts as followed.

A first part comprises the step 1 of nano-catalytic electrolysis and a pre-processing part of the step 2 of flocculation and sedimentation. In the first part, after large particle impurities comprising furs and meat residue in the wastewater are removed by coarse grid filtration, the wastewater flows into the regulating pool to mix. After the impurities comprising hairs are removed by hydraulic sieve filtration, the wastewater is nano-catalytically electrolyzed, in such a manner that the organic matter is oxidized and decomposed. After the suspended solids and the colloidal matter are settled down, the solid impurities and oil floating on a surface are removed by air floatation. Then the flocculant, the coagulant aid and the air flotation are added in to proceed the flocculation reaction. Most of the organic matter and salts are settled down in the first part. The COD is decreased to less than 1500 mg/L from 3000˜4000 mg/L, in order to ensure a biochemical system in a second part to operate steadily for long.

The second part comprises the step 3 of the biochemical treatment and the step 4 of the secondary nano-catalytic electrolysis. The COD, pigment, and ammonia nitrogen in the wastewater are removed by the biochemical treatment and the secondary nano-catalytic electrolysis, in such manner that the quality of the treated wastewater meets the requirement for the membrane system to operate steadily for long. The step 3 of the biochemical treatment comprises the aerobic treatment or the treatment combining the anaerobic treatment and the aerobic treatment, the secondary sedimentation, etc.

The third part comprises the step 5 of the filtration and the step 6 of the membrane filtration. The wastewater treated in the second part is filtered in the step 5, in order to further remove the impurities comprising suspended solids. Then the wastewater flows into the membrane filtration system in the step 6 to be separated into the dialysate and concentrate, wherein the dialysate is the reusable water reused for the production. The concentrate is tested. If the concentrate meets discharge standards, the concentrate will be discharged directly; if not, the concentrate will be biochemical treated again as recited in the step 3.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A tanning wastewater treatment and recycling device based on nano-catalytic electrolysis technology and membrane technology, comprising: a coarse grid filtering machine, a regulating pool, a hydraulic sieve, a nano-catalytic electrolytic machine, a reaction pool, a sedimentation pool, an air flotation device, a biochemical pool, a secondary sedimentation pool, a secondary nano-catalytic electrolytic machine, a filter and a membrane system, wherein a wastewater inlet of said coarse grid filtering machine is connected with a synthetic wastewater source, a filtered wastewater outlet of said coarse grid filtering machine is connected with an inlet of said regulating pool, an inlet of said hydraulic sieve is connected with a wastewater outlet of said regulating pool, an inlet of said nano-catalytic electrolytic machine is connected with an outlet of said hydraulic sieve, an outlet of said nano-catalytic electrolytic machine is connected with an inlet of said reaction pool, an outlet of said reaction pool is connected with an inlet of said sedimentation pool, precipitates outflowing from a sedimentation outlet of said sedimentation pool are pumped into a pressure filter via a pipeline to be filtered and separated into filtrate and sludges, a wastewater outlet of said sedimentation pool is connected with an inlet of said air flotation device, residues outflowing from a residue outlet in an upper portion of said air flotation device are pumped into said pressure filter via a pipeline to be filtered and separated into filtrate and sludges, the filtrate outflowing from a filtrate outlet of said pressure filter flows into said biochemical pool via a pipeline, a wastewater outlet in a lower portion of said air flotation device is connected with said biochemical pool via a pump, an outlet of said biochemical pool is connected with an inlet of said secondary sedimentation pool, an outlet for the biochemically-treated wastewater in an upper portion of said secondary sedimentation pool is connected with an inlet of said secondary nano-catalytic electrolytic machine, precipitates outflowing from a sedimentation outlet in a bottom of said secondary sedimentation pool are pumped into said pressure filter via a pipeline to be filtered and separated into filtrate and sludges, the filtrate flows into said secondary sedimentation pool via a pipeline, a wastewater outlet of said secondary nano-catalytic electrolytic machine is connected with an inlet of said filter, an outlet for the wastewater filtered by said filter is connected with an inlet of said membrane system, and said membrane system has a dialysate outlet and a concentrate outlet.

2. A tanning wastewater treatment and recycling method based on nano-catalytic electrolysis technology and membrane technology, applying the tanning wastewater treatment and recycling device based on the nano-catalytic electrolysis technology and the membrane technology as recited in claim 1, comprising steps of:
1) nano-catalytic electrolysis,
wherein tanning synthetic wastewater flows into a coarse grid filtering machine, after removing large particulate solids, the tanning synthetic wastewater flows into a regulating pool to mix, then the wastewater in the regulating pool is pumped into a hydraulic sieve, and after impurities comprising hairs are filtered and removed, the wastewater flows into a nano-catalytic electrolytic machine to be electrolyzed;
2) flocculation,
wherein the wastewater electrolyzed by the nano-catalytic electrolytic machine in the step 1) flows into a reaction pool, then flocculant, coagulant aid and air flotation agent prepared in advance are added into the reaction pool, after a flocculation reaction, the wastewater flows into a sedimentation pool to be separated, precipitates in an lower portion of the sedimentation pool are pumped into a pressure filter via a pipeline to be filtered and separated into filtrate and sludges, the wastewater in an upper portion of the sedimentation pool flows into an air flotation device to be separated via air flotation, residues separated in an upper portion of the air flotation device are pumped into the pressure filter via a pipeline to be filtered and separated into filtrate and sludges, the filtrate flows into a biochemical pool via a pipeline, and the wastewater in an lower portion of the air flotation device is pumped into the biochemical pool;
3) biochemical treatment,
wherein the wastewater in the lower portion of the air flotation device, which is treated by the flocculation in the step 2), is pumped into the biochemical pool, the wastewater is treated by an aerobic method or a method combining anaerobic treatment and aerobic treatment, and then is separated by settling in a secondary sedimentation pool, the wastewater treated by a biochemical treatment outflows from an upper portion of the secondary sedimentation pool, sediment in a bottom of the secondary sedimentation pool is pumped into the pressure filter via a pipeline to be filtered and separated into filtrate and sludges, the filtrate flows into the secondary sedimentation pool via a pipeline, and after the biochemical treatment, the biochemically-treated wastewater separated by settling in the secondary sedimentation pool is obtained;
4) secondary catalytic electrolysis,
comprising transmitting the biochemically-treated wastewater outflowing from the upper portion of the secondary sedimentation pool into a secondary nano-catalytic electrolytic machine to electrolyze the wastewater;
5) filtration,
comprising filtering the wastewater electrolyzed by the secondary nano-catalytic electrolytic machine with a filter, and removing solid impurities; and
6) membrane filtration
comprising filtering the wastewater filtered by the filter with a membrane system to obtain dialysate and concentrate, wherein the dialysate is reused, and the concentrate is discharged.

3. The tanning wastewater treatment and recycling method based on the nano-catalytic electrolysis technology and the membrane technology, as recited in claim 2, wherein, in the step 1), the nano-catalytic electrolytic machine has an electrolysis working voltage of 2-500V, a voltage between two poles of 2-8V, and an electrolytic density of 10-300 mA/cm², a retention time of the wastewater in the nano-catalytic electrolytic machine is 5-15 min, and electricity consumption of electrolyzing the wastewater is 8-1.2 kilowatt hour/m³.

4. The tanning wastewater treatment and recycling method based on the nano-catalytic electrolysis technology and the membrane technology, as recited in claim 2, wherein, in the step 4), an electrolysis working voltage of the secondary nano-catalytic electrolytic machine is 2-400V, a voltage between two poles is 2-8V, a current density is 10-300 mA/cm², a retention time of the wastewater in the secondary nano-catalytic electrolytic machine is 2-6 min, and a degree of electrolysis is 0.8˜1.0 kilowatt hour/m³.

5. The tanning wastewater treatment and recycling method based on the nano-catalytic electrolysis technology and the membrane technology, as recited in claim 4, wherein the electrolysis working voltage of the secondary nano-catalytic electrolytic machine is 13-200V, the voltage between two poles is 3-5V, the current density is 150-230 mA/cm², and the retention time of the wastewater in the secondary nano-catalytic electrolytic machine is 3-4 min.

6. The tanning wastewater treatment and recycling method based on the nano-catalytic electrolysis technology and the membrane technology, as recited in claim 2, wherein, in the step 5), the filter is a sand filter, a multi-media filter, or a microfiltration membrane system.

7. The tanning wastewater treatment and recycling method based on the nano-catalytic electrolysis technology and the membrane technology, as recited in claim 2, wherein, in the step 6), the membrane system is a nanofiltration membrane system or a reverse osmosis membrane system.

8. The tanning wastewater treatment and recycling method based on the nano-catalytic electrolysis technology and the membrane technology, as recited in claim 7, wherein a membrane module of the nanofiltration membrane system is a roll-type membrane module, a membrane material of the nanofiltration membrane system is a cellulose acetate membrane or a composite membrane of organic membranes, which has a molecular weight cutoff of 50˜200 MWCO, an inlet pressure of 6.0˜45.0 bar, and an outlet pressure of 4.5˜43.5 bar.

9. The tanning wastewater treatment and recycling method based on the nano-catalytic electrolysis technology and the membrane technology, as recited in claim 7, wherein a membrane module of the reverse osmosis membrane system is a roll-type membrane module, a membrane material of the reverse osmosis membrane system is a cellulose acetate membrane or a composite membrane of organic membranes, which has a molecular weight cutoff of 50˜200 MWCO, an inlet pressure of 6.0˜45.0 bar, and an outlet pressure of 4.5˜35 bar.
